(19) United States
(12) Patent Application Publication
(10) Pub. No.: US 2006/0264231 A1
(43) Pub. Date: Nov. 23, 2006

(54) System and/or method for speed estimation in communication systems

(76) Inventors: Hong Zhang, Edison, NJ (US); Ali Abdi, New Milford, NJ (US)

Correspondence Address: BERKELEY LAW & TECHNOLOGY GROUP, 1700NW 167TH PLACE, SUITE 240, BEAVERTON, OR, 97006, US

(21) Appl. No.: 11/336,301

(22) Filed: Jan. 20, 2006

Related U.S. Application Data
(60) Provisional application No. 60/645,577, filed on Jan. 20, 2005.

(51) Int. Cl. H04B 7/00

(52) U.S. Cl. 455/523

(57) ABSTRACT

Embodiments of methods, devices and/or systems for estimating channel state information are described.

### RELATED APPLICATION

The current patent application claims priority to U.S. Provisional Patent Application No. 60/645,577, filed on Jan. 20^{th}, 2005, titled “Robust Mobile Velocity Estimator for Wireless System”, assigned to the assignee of the presently claimed subject matter.

### FIELD

This disclosure is related to communications.

### BACKGROUND

It may be desirable in communications systems to have the capability of performing speed estimation, such as in a wireless communication system.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIGS. 1-5 are plots illustrating simulated performance results of employing various embodiments of a method of speed estimation.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail so as not to obscure claimed subject matter.

Some portions of the detailed description which follow are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the communications and/or data processing arts to convey the substance of their work to others skilled in the art. An algorithm is, generally, considered to be a self-consistent sequence of operations and/or similar processing leading to a desired result. The operations and/or processing may involve physical manipulations of physical quantities. Typically, although not necessarily, these quantities may take the form of electrical and/or magnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” and/or “an embodiment” in various places throughout this specification are not necessarily all referring to the same embodiment. Furthermore, the particular features, structures, and/or characteristics may be combined in one or more embodiments.

Unless specifically stated otherwise, as apparent from the following discussion, it is appreciated that throughout this specification discussions utilizing terms such as “calculating,” “determining” and/or the like refer to the actions and/or processes that may be performed by a computing platform, such as a computer or a similar electronic computing device, that manipulates and/or transforms data represented as physical, electronic and/or magnetic quantities and/or other physical quantities within the computing platform's processors, memories, registers, and/or other information storage, transmission, reception and/or display devices. Accordingly, a computing platform refers to a system or a device that includes the ability to process and/or store data in the form of signals. Thus, a computing platform, in this context, may comprise hardware, software, firmware and/or any combination thereof. Further, unless specifically stated otherwise, a process as described herein, with reference to flow diagrams or otherwise, may also be executed and/or controlled, in whole or in part, by a computing platform.

The following discussion details several possible embodiments, although these are merely examples and are not intended to limit the scope of claimed subject matter. As another example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with claimed subject matter being executed, such as one of the embodiments previously described, for example. Embodiments may be employed in a variety of possible communications devices, including, for example, cell phones, personal digital assistants, laptop computers, media players and the like. Of course, claimed subject matter is not limited to just these examples.

Communication systems may be adapted to send and/or receive data signals. The data signals may be sent and/or received between two or more portions of a communication system. For example, a communication system may include one or more mobile terminals, and may include GSM, 3G, WiMax, WCDMA and/or CS-TAMA compliant components, and may operate substantially in accordance with GSM, 3G, WiMax, WCDMA and/or CS-TAMA compliant schemes, to name a few examples. However, it is worthwhile to note that the claimed subject matter is not so limited. Additionally, wireless communication systems such as these may employ a single input, single output (SISO) scheme and/or a multiple input multiple output (MIMO) scheme, for example. The wireless communication system may additionally employ narrowband and/or wideband channels. However, again, the claimed subject matter is not so limited. It may be desirable, for a variety of reasons, to estimate the maximum Doppler frequency and/or the mobile speed of at least a portion of a communication system. Speed and/or Doppler frequency estimation schemes as set forth herein may be applicable at least a portion of a communication system as set forth herein, such as to mobile and/or base stations of a communication system, although the claimed subject matter is not limited in this respect.

The mobile speed of a communication system may indicate the rate of channel variations within one or more portions of the system. Knowledge of mobile speed may be desirable for communication systems that employ handoff, adaptive modulation, equalization, and/or power control, to name a few examples. See, for example, A. Abdi, K. Wills, H. A. Barger, M. S. Alouini, and M. Kaveh, “Comparison of the level crossing rate and average fade duration of Rayleigh, Rice, and Nakagami fading models with mobile channel data,” in Proc. IEEE Vehic. Technol. Conf, Boston, Mass., 2000, pp. 1850-1857, hereinafter reference [1]. Although estimation of mobile speed may be desirable in existing schemes such as GSM, 3G and WiMax compliant schemes, additional schemes now existing or later developed may utilize mobile speed estimation. Additionally, mobile speed may be referred to as velocity, in at least one embodiment.

At least three classes of speed estimation schemes may be utilized in communication systems. These three classes comprise crossing-based methods, covariance-based methods and maximum likelihood (ML) based methods. However, crossing based and covariance based schemes may be sensitive to noise. Additionally, existing estimation schemes may be based on 2-D angle of arrival (AOA) scattering assumptions, which may additionally be sensitive to noise and/or other uncertainties. See, for example, G. L. Stuber, Principles of Mobile Communication, 2nd ed., Boston, Mass.: Kluwer, 2001, hereinafter reference [2]; A. Abdi and M. Kaveh, A new velocity estimator for cellular systems based on higher order crossings, in Proc. Asilomar Conf. Signals, Systems, Computers, Pacific Grove, Calif., 1998, pp. 1423-1427, hereinafter reference [3]; C. Tepedelenlioglu, A. Abdi, G. B. Giannakis, and M. Kaveh, “Estimation of Doppler spread and signal strength in mobile communications with applications to handoff and adaptive transmission,” Wirel. Commun. Mob. Comput., vol. 1, pp. 221-242, 2001 hereinafter reference [4]; A. Abdi, H. Zhang, and C. Tepedelenlioglu, “Speed Estimation Techniques in Cellular Systems: Unified Performance Analysis,” in Proc. IEEE Vehic. Technol. Conf., Orlando, Fla., 2003, hereinafter reference [5]; H. Zhang and A. Abdi, “Mobile speed estimation using diversity combining in fading channels,” Proc. IEEE Global Telecommun. Conf, Dallas, Tex., 2004, hereinafter reference [6]; and/or Xuefeng Yin, B. H. Fleury, P. Jourdan, A. Stucki, “Doppler frequency estimation for channel sounding using switched multiple-element transmit and receive antennas,” IEEE Global Telecommunications Conference, San Francisco, Calif., 2003, hereinafter reference [7].

It may be desirable to develop a speed estimation scheme that addresses one or more of the above-noted limitations. For example, a speed estimation scheme may be employed that is adapted to utilize characteristics of power spectra of mobile fading channels of a communication system, for example. Additionally, speed estimation schemes in accordance with one or more embodiments may be robust with respect to noise, such as with respect to Gaussian and non-Gaussian based noise, may have a relatively low sensitivity to one or more of nonisotropic scattering and line of sight (LOS), and may have a lower complexity than one or more existing speed estimation schemes, for example. A speed estimation scheme that may be applicable to both single-antenna systems and multiple antenna systems, such as mobile station (MS) having a single antenna, and/or a multiple-antenna base station (BS), to name a few examples. As will be explained in more detail later, a speed estimation scheme in accordance with one or more embodiments may employ an estimate of the power spectral density of a received signal in a wireless communication system, for example.

It may be desirable to model signal, channel and/or noise components for purposes of developing and/or evaluating a speed estimation scheme. Consider a received lowpass complex envelope in a noisy Rayleigh frequency-flat fading channel of a communication system, which may be at least partially modeled by the following equation:
z(t)=h(t)+n(t) (1)

wherein the zero-mean circular complex Gaussian processes h(t) may represent the channel gain, if, for example, a pilot gain has been transmitted, and and n(t) may represent the bandlimited additive noise of bandwidth B Hz, for example. In Cartesian coordinates, equation (1) may be rewritten as:
z(t)=x(t)+jy(t) (2)

wherein j²=−1 and x(t) and y(t) may comprise inphase and quadrature components, respectively.

In one embodiment, an autocorrelation function of h(t) may be defined by the following equation:
Cₕ(τ)=E[h(t)h*(t+τ)] (3)

Consider an embodiment wherein a general 3-D AOA model for a wireless communication system that may employ one or more isotropic receiving antennae having unit-gain. In this embodiment, Cₕ(τ) may be expressed by the following equation:
Cₕ(τ)=P₀∫_{θ=0}^{π}∫_{φ=0}^{2π}e^{j2πf}^{_{D}} ^{cos φ sin θ}q(θ)p(φ)sin θdφ dθ (4)

wherein P₀ comprises total received power of an antenna of the system, p(φ) and q(θ) comprise probability density functions (PDF) of the AOAs in the azimuth and elevation planes, respectively. Additionally, f_{D}=v/λ=vf_{c}/c, wherein c comprises the speed of light. For a 2-D AOA having a distribution such as a Von Mise distribution, an empirically-verified correlation may be explained, at least in part, by A. Abdi, J. A. Barger, and M. Kaveh, “A parametric model for the distribution of the angle of arrival and the associated correlation function and power spectrum at the mobile station,” IEEE Trans. Vehic. Technol., vol. 51, pp. 425-434, 2002, hereinafter reference [8]. Additionally, reference [8] may comprise an extension of Clark's model, which may additionally be referred to as Jake's model, shown at least in part by the following equation:

$${C}_{h}^{2 D} ( τ ) = {P}_{0} \frac{{I}_{0} ( \sqrt{{κ}^{2} - 4 π {f}_{D}^{2} {τ}^{2} + j 4 π κ cos ( α ) {f}_{D} τ )}}{{I}_{0} ( κ )} \qquad ( 5 )$$

wherein αᵢ ε[−π,π) comprises the mean direction of the AOA, κᵢ≧0 controls the width of the AOA, I₀(.) comprises a zero-order modified Bessel function of the first kind.

Consequently, the power spectral density (PSD) of h(t) may be shown by the following equation:

$${S}_{h}^{2 D} ( f ) = \frac{{P}_{0}}{π \sqrt{{f}_{D}^{2} - {f}^{2}}} \frac{{ⅇ}^{κ cos α \frac{f}{{f}_{D}}}}{{I}_{0} ( κ )} cos h ( κ sin α \sqrt{1 - {( \frac{f}{{f}_{D}} )}^{2}} ) , \\ \vert f \vert \leq {f}_{D} \qquad ( 6 )$$

Additonally, see, for example, T. Aulin, “A modified model for the fading signal at a mobile radio channel,” IEEE Trans. Veh. Technol., vol. VT-28, pp. 182-203, August 1979, hereinafter, reference [9].

For a 3-D AOA, consider an embodiment wherein signals may be provided from a plurality of angles in the azimuth plane with equal probability and signals may be provided from limited angular region ±Δβ about the horizon, then:

$${C}_{h}^{3 D} ( τ ) = \frac{{P}_{0}}{2 sin ( Δ β )} {\int }_{θ = \frac{π}{2} - Δ β}^{\frac{π}{2} + Δ β} {J}_{0} ( 2 π {f}_{D} τ sin ( θ ) ) sin ( θ ) ⅆ θ \qquad ( 7 )$$

in which J₀(.) may comprise the zero-order Bessel function of the first kind. A corresponding power spectral density of h(t) may be shown as:

$${S}_{h}^{3 D} ( f ) = \{ \begin{matrix}\frac{{P}_{0}}{π {f}_{D} sin ( Δ β )} {sin}^{- 1} ( \frac{sin ( Δ β )}{cos ( Δ β f )} ) , & 0 \leq \vert f \vert < {f}_{D} cos ( Δ β ) \\ \frac{{P}_{0}}{2 {f}_{D} sin ( Δ β )} , & {f}_{D} cos ( Δ β ) \leq \vert f \vert \leq {f}_{D}\end{matrix} \qquad ( 8 )$$

In one embodiment, the autocorrelation function of a Rician fading channel may comprise:

$${C}_{h}^{Rician} ( τ ) = \frac{{P}_{0}}{K + 1} {C}_{h} ( τ ) + \frac{K {P}_{0}}{K + 1} exp [ - j 2 π {f}_{D} cos ( {α}_{0} ) τ ] \qquad ( 9 )$$

wherein α₀ may comprise the AOA of a line-of-sight (LOS) component in the horizontal plane, K may comprise the Rice factor, which may comprise the ratio of the LOS power to the diffuse power, for example.

Characteristics of the PSDs may be checked to observe the occurrence of one or more of singularities or maxima at the maximum Doppler frequency, for example. PSDs of a random signal may be estimated as described in the following: Petre Stoica, Randolph L. Moses, “Introduction to Spectral Analysis,” Prentice Hall; 1st ed. 1997, hereinafter reference [10]. However, the claimed subject matter is not so limited. For example, normal periodogram-based spectrum estimation schemes may be employed in at least one alternative embodiment.

Consider an N-sample discrete signal of z(t) with a duration of T seconds, {Z(n)=X(n)+jY(n))}ₙ₌₁^{N}. In this embodiment, the estimated PSD may comprise:

$${\hat{S}}_{z} ( {f}_{k} ) = \frac{1}{N} {\vert {\sum }_{n = 1}^{N} Z ( n ) {ⅇ}^{- j 2 π {f}_{k} n} \vert}^{2} , {f}_{k} = \frac{k}{N} {f}_{s} , k = 1 , … , N \qquad ( 10 )$$

wherein fₛ=N/T comprises a sampling frequency of received signal z(t).

An estimation scheme may then be represented as:

$${\hat{f}}_{D} = arg {max}_{{f}_{k}} ( \hat{S} ( {f}_{k} ) ) . \qquad ( 11 )$$

Speed estimation for a wireless communication system may be performed, at least in part, by employing one or more of the schemes as set forth above. However, estimation schemes such as these may have a particular performance. It may be desirable to measure the performance of an estimation scheme. For example, performance may be measured by employing mean squared error (MSE) criterion. For example, the performance of the estimation scheme as employed in a communication system may be determined, at least in part, by utilizing the MSE, which may be determined based at least in part on the following equations (12)-(14):
E[(\hat{f}_{D}−f_{D})²]=Var[\hat{f}_{D}]+(E[\hat{f}_{D}]−f_{D})² (12)

wherein the first term E[(\hat{f}_{D}−f_{D})²] comprises the variance, and the second term Var[\hat{f}_{D}]+(E[\hat{f}_{D}]−f_{D})² comprises the bias.

A derivation of Ŝ_{z}(fₖ) may be utilized to derive the variance and/or the bias of the estimation scheme explained previously. The derivation may produce the following equation:

$${p}_{{\hat{f}}_{D}} ( {f}_{i} ) = 1 + {\sum }_{m = 1}^{N - 1} {( - 1 )}^{m} {\sum }_{{{n}_{1} = 1}_{{{\{ {n}_{j} \}}_{j = 1}^{m} = j}_{{n}_{m} > … > {n}_{2} > {n}_{1}}}}^{N} \frac{1}{1 + {\sum }_{j = 1}^{m} \frac{{S}_{z} ( {f}_{i} )}{{S}_{z} ( {f}_{{n}_{j}} )}} . \qquad ( 13 )$$

and, based at least in part on equation (12) and/or equation (13), the MSE of the estimation scheme may be shown as:

$$E [ {( {\hat{f}}_{D} - {f}_{D} )}^{2} ] = {\sum }_{i = 1}^{N} {f}_{i} {p}_{{\hat{f}}_{D}} ( {f}_{i} ) + {\sum }_{i = 1}^{N} {( {f}_{i} - {f}_{D} )}^{2} {p}_{{\hat{f}}_{D}} ( {f}_{i} ) \qquad ( 14 )$$

Simulations were carried out to further investigate the performance of a theoretical MSE and/or a Monte Carlo simulation, and compare the performance of the above-described scheme with one or more other speed estimation techniques, including crossing-based speed estimation and covariance-based speed estimation. In one simulation, a zero-mean complex Gaussian process using a spectral method as set forth in K. Acolatse and A. Abdi, “Efficient simulation of space-time correlated MIMO mobile fading channels,” in Proc. IEEE Vehic. Technol. Conf, Orlando, Fla., 2003, hereinafter, reference [11] was employed.

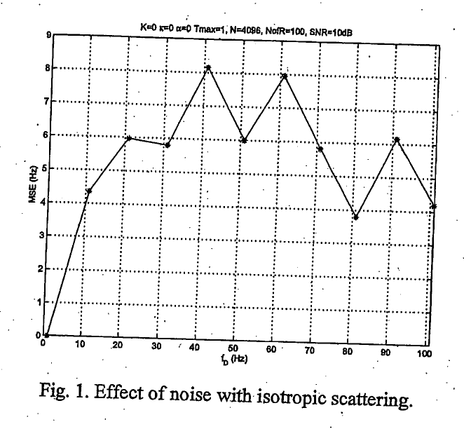

Illustrated in FIG. 1 is the estimation error versus f_{D}. In this plot, and assumption of a 2-D AOA model and isotropic scattering having a signal-to-noise ratio of 10 dB is assumed. This plot demonstrates the effect of noise, and for at least one embodiment of the above-described speed estimation scheme may demonstrate relatively strong resistance to noise, for example.

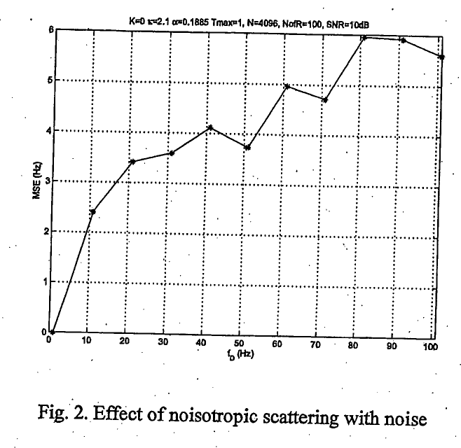

Illustrated in FIG. 2 is a plot that may illustrate the effect of non-isotropic scattering for at least one embodiment of a speed estimation scheme. This plot may demonstrate that for at least one embodiment of a speed estimation scheme, at least one characteristic may comprise relatively low sensitivity to a scattering environment.

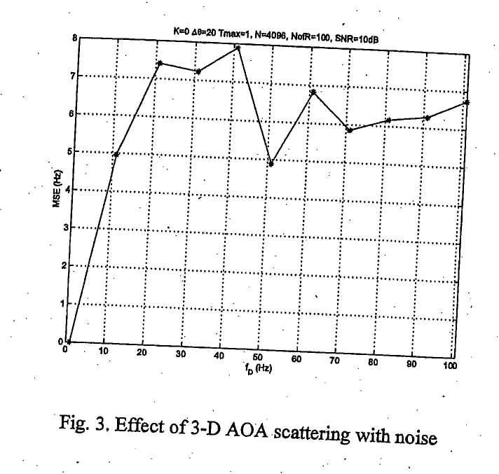

Illustrated in FIG. 3 is a plot that may illustrate the effect of 3-D AOA for at least one embodiment of a speed estimation scheme. This plot may demonstrate that for at least one embodiment of a speed estimation scheme, performance may not be unduly affected in a noisy 3-D AOA environment.

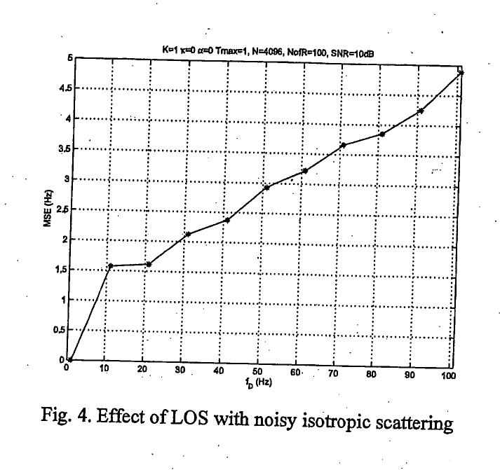

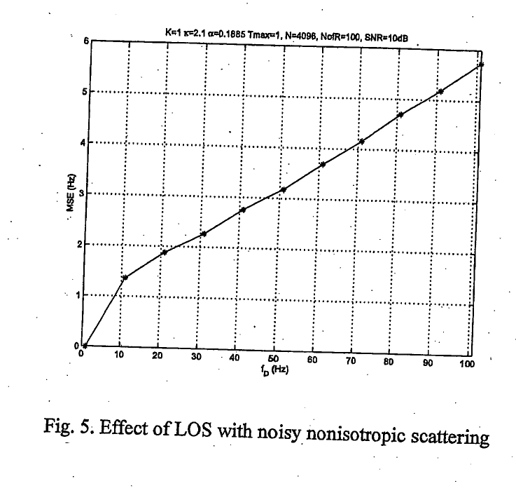

Illustrated in FIGS. 4 and 5 are plots that may illustrate the effect of Rician factor K for at least one embodiment of a speed estimation scheme. These plots may demonstrate that for at least one embodiment of a speed estimation scheme, strong robustness against Rician factor K may exist.

In the preceding description, various aspects of claimed subject matter have been described. For purposes of explanation, systems and configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method of estimating speed in a wireless communication system, comprising:
receiving a signal;
determining one or more characteristics of a power spectral density of at least a portion of the received signal; and
estimating one or more characteristics of the wireless communication system based at least in part on the determined power spectral density.

2. The method of claim 1, wherein one or more characteristics comprise the speed of at least a portion of the wireless communication system.

3. The method of claim 1, wherein the speed further comprises the mobile speed associated with a mobile terminal of the wireless communication system.

4. The method of claim 3, wherein one or more characteristics comprise the maximum Doppler frequency associated with at least a portion of the wireless communication system.

5. The method of claim 4, wherein the maximum Doppler frequency is associated with the mobile terminal of the wireless communication system.

6. The method of claim 1, wherein the power spectral density comprises the power spectral density of a channel of the wireless communication system.

7. The method of claim 3, wherein the speed comprises the rate of channel variations for the mobile terminal of the wireless communication system.

8. The method of claim 1, wherein determining the power spectral density comprises estimating the power spectral density based at least in part on one or more characteristics of the received signal.

9. An apparatus, comprising:
a wireless communication system receiver;
said receiver adapted to receive a wireless signal, determine one or more characteristics of the power spectral density of at least a portion of the received signal, and estimate one or more characteristics of the wireless communication system based at least in part on the determined power spectral density.

10. The apparatus of claim 9, wherein said receiver comprises a mobile terminal of the wireless communication system.

11. The apparatus of claim 9, wherein said wireless communication system employs at least one of: a GSM scheme, a 3G scheme, a WiMax Scheme, a WCDMA scheme and/or a TDS-CAMA scheme.

12. The apparatus of claim 9, wherein one or more characteristics comprise the speed of at least a portion of the wireless communication system.

13. The apparatus of claim 10, wherein the speed further comprises the mobile speed of the mobile terminal of the wireless communication system.

14. The apparatus of claim 9, wherein one or more characteristics comprise the maximum Doppler frequency associated with at least a portion of the wireless communication system.

15. The apparatus of claim 14, wherein the maximum Doppler frequency is associated with a mobile terminal of the wireless communication system.

16. The apparatus of claim 9, wherein the power-spectral density comprises the power spectral density of a mobile channel of the wireless communication system.

17. The apparatus of claim 16, wherein the speed comprises the rate of channel variations for the mobile terminal of the wireless communication system.

18. The apparatus of claim 9, wherein determining the power spectral density comprises estimating the power spectral density based at least in part on one or more characteristics of the received signal.

19. The apparatus of claim 9, wherein said receiver is incorporated in at least one of the following: a cell phone; a personal digital assistant; a laptop computer; a media player device.

20. An apparatus, comprising:
a computing device;
said computing device adapted to receive a wireless signal from a wireless communication system, determine one or more characteristics of the power spectral density of at least a portion of the received signal, and estimate one or more characteristics of the wireless communication system based at least in part on the determined power spectral density.

21. The apparatus of claim 20, wherein said computing system comprises a mobile terminal of the wireless communication system.

22. The apparatus of claim 20, wherein said wireless communication system employs at least one of: a GSM scheme, a 3G scheme, a WiMax Scheme, a WCDMA scheme and/or a TDS-CAMA scheme.

23. The apparatus of claim 20, wherein one or more characteristics comprise the speed of at least a portion of the wireless communication system.

24. The apparatus of claim 23, wherein the speed further comprises the mobile speed of the mobile terminal of the wireless communication system.

25. The apparatus of claim 20, wherein one or more characteristics comprise the maximum Doppler frequency associated with at least a portion of the wireless communication system.

26. The apparatus of claim 25, wherein the maximum Doppler frequency is associated with a mobile terminal of the wireless communication system.

27. The apparatus of claim 20, wherein the power spectral density comprises the power spectral density of a mobile channel of the wireless communication system.

28. The apparatus of claim 24, wherein the speed comprises the rate of channel variations for the mobile terminal of the wireless communication system.

29. The apparatus of claim 20, wherein determining the power spectral density comprises estimating the power spectral density based at least in part on one or more characteristics of the received signal.

30. The apparatus of claim 20, wherein said computing system comprises at least one of the following: a cell phone; a personal digital assistant; a laptop computer; a media player device.
